(19) United States
(12) Patent Application Publication
(10) Pub. No.: US 2005/0210724 A1
(43) Pub. Date: Sep. 29, 2005

(54) Support for signs incorporating an electrical raceway therefor and sign and method utilizing the same

(76) Inventors: William A. Grau, Englewood, CO (US); Joseph O. Church, Englewood, CO (US)

Correspondence Address: TIMOTHY J MARTIN, PC, 9250 W 5TH AVENUE, SUITE 200, LAKEWOOD, CO, 80226, US

(21) Appl. No.: 11/053,506

(22) Filed: Feb. 7, 2005

Related U.S. Application Data
(60) Provisional application No. 60/542,620, filed on Feb. 5, 2004.

(51) Int. Cl. G09F 15/00; G09F 13/26

(52) U.S. Cl. 40/606.01; 40/545; 40/607.13

(57) ABSTRACT

A support structure for a sign includes a longitudinal housing having an pen front and adapted to be secured to an upright surface. At least one gusset panel is oriented transversely in the interior of the housing. The gusset panel has a forwardly disposed notch facing the open front. In one embodiment, the housing includes a primary panel forming a bottom wall and a rear wall. A front panel strip is supported at the upper front of the gusset panel. End panels, which may be gussets, may be used to close the ends of the housing. The top of the housing may be open and a removable lid may be used to enclose the open top. A sign is also disclosed wherein a longitudinal faceplate extends across the open front and carries at least one display character.

### FIELD OF THE INVENTION

The present invention broadly concerns formed metal housings adapted to support display signs. More particularly, the present invention relates to a standardized support to which alternative signs may be mounted. The invention specifically concerns a standardized support and a method that includes an electrical raceway so as to mount neon signs. The present invention also concerns signs that incorporate such a support.

### BACKGROUND OF THE INVENTION

In the modern world, it has become increasingly important for business owners to communicate to the public the nature of their goods and services. While a variety of advertising techniques are available, one of the more prolific is the use of signs that either identify the business by name, by the types of goods or services offered, or by a combination of the two. In some cases, signs advertising a business are placed a spaced location from the business itself such as adjacent a thoroughfare traveled by prospective customers. In other cases, signs are posted directly at the premises of the business. For example, a sign may be posted on a facade above the entryway to a business so that customers may identify the location of the business.

Often times, businesses congregate in a common district so that a variety of goods and services are available in a concentrated location ostensibly for the convenience of customers seeking such goods and services. Thus, historically, many towns and cities developed one or more “business districts” with residential communities typically surrounding such business districts. In the last century, and especially due to the advent of extensive motorized transportation, businesses have conglomerated in shopping malls. Such shopping malls are typically real estate developments wherein an owner provides a building that houses numerous individual stores or shops that can, in turn, offer a variety of goods and services for customers in the mall.

Shopping malls are usually one or the other of two types. One such type is referred to the “strip-mall”. Strip-malls traditionally have a series of businesses organized in a side-by-side manner along one or more edges of a shopping area. Adjacent businesses have adjoining walls, and each business generally has its own entryway, and a customer must exit the building to travel from one business to another. A second type is an enclosed shopping mall that typically takes the form of a large building that is centrally located in a surrounding parking region. Several major entryways are provided to the building, and a plurality of businesses are housed within the building. These businesses typically have entryways that open into large hall-like common areas. Once a customer enters the mall, then, he/she can travel from business to business without exiting the building.

Whether businesses are housed in stand alone units, in buildings containing multiple units, in strip-malls or in enclosed malls, business owners typically identify their business with various types of signs, as noted above. Such signs can be simple placard-type signs wherein words and/or artwork are printed, painted or otherwise placed on a substrate. Sometimes these substrates are externally or internally lit so as to facilitate visual perception of the sign, especially at night. Alternatively, it is known to provide electrical signs wherein the words, symbols or artwork are fabricated out of luminous elements, a primary example of which being the well-known neon light.

In neon lights, symbols, individual characters or words made of a plurality of characters are fabricated out of configured tubes of glass. These tubes are filled with neon gas, and, upon the application of a substantial voltage, the atoms of the gas become electrically excited so as to emit light. Such neon signs accordingly require electrical transformers and associated electrical wiring to the neon tubes.

In the past, neon signs have been constructed by placing the symbols, characters or words on a supporting faceplate which provides a support panel and background for the sign. Once the sign had been constructed, a support housing was fabricated with this housing being matched to the size of the faceplate and with a depth sufficient to house the transformer and electrical wiring for the sign. Typically the housings were constructed by having an edge framework of angled metal, such as steel, to which was mounted a metal skin so as to form an enclosed, elongated rectangular box which housed the electrical components and protected the same from the external environment. Each such support box was, accordingly, customized for the particular sign.

This technique has been found not only to be expensive since, each time a change in signing is desired, a new faceplate as well as a new customized box support is necessary to complete the sign. Moreover, since each customized box must be mounted to the premises of the building, mounting holes are drilled, for example, into an upper facade of the building, so that the support housing could be mounted to the facade and the sign suspended above the entryway of the business. Sign makers normally determine the location and number of the mounts for the housing according to the size and configuration thereof. Over a course of time, the change in signs resulting from either the change in business identities or a change in image desired to be projected by the business results in numerous mounting holes being formed in the facade.

This procedure, of course, can be very costly and unsightly. On one hand, as more and more holes are formed in the facade, the presence of holes naturally detracts from the visual appearance of the facade. The excess number of holes also create entryways into the building facade for numerous pests. For example, hive insects such as bees, wasps, hornets and the like can enter into the holes and create hives or nests in the interior structure of the building. Such insects are known to be poisonous and present a potential threat to humans accessing the buildings with such threat ranging from minor stings to more serious conditions resulting to allergic reactions to such stings. Where holes are made of sufficient size, birds may undesirably nest in the facade, and small animals such as mice and the like may also infest the building through the ingress permitted by these access holes. Removal of these insects and vermin can itself be expensive.

After a period of time, it accordingly becomes necessary to replace the facade of the building due to the plethora of holes that, over time, become created in the facade. Where the storefronts are designed to have an upscale image, these facades can be very expensive due to the use of expensive and aesthetically pleasing materials. Therefore, the replacement of a facade, whether by the business owner or by the premises owner results in an undesirable expense that must, ultimately, be born by the price of goods and services provided to customers.

A further disadvantage of customized signs is the creation of a disorganized appearance where the businesses are located side by side. Where each sign is different, a disorganized or random appearance for the overall aesthetic look of the building occurs. This can be visually and aesthetically unpleasing. Accordingly, many landlords require at least some uniformity in the type and style of sign for each business located on the premises. Even with such a requirement, however, the support housing for the signs are each different, due to their customized nature.

A further aesthetic disadvantage also results from this existing custom made sign procedure. Where upscale, high-end paneling is used for facades, this paneling is normally specified by architects who have a calculated color theme or other aesthetic features. The signage housings, however, are typically not matched to this color theme. The different size and colorings of the signage housing can therefore detract, again, from the visual appearance of the overall decor of the building. This leads to an undesirable cheapening of the look and feel of the premises.

Accordingly, there has been a long felt need for signage structures that have a reduced cost associated therewith. There is a further need for standardized signage supports which do not need to be customized for each individual sign associated therewith. There is a further need for standardized housing for signage which can be readily permanently affixed to the facade of the building and can support different signs as the identity of the business or the image projected by the business is desired to be changed. There is further a need for standardized housing for signs which housing can be color coordinated with the color themes of the building. Finally, there is a need to provide a housing which can be relatively permanently secured to the facade of a building so as to avoid the need for drilling numerous holes in that facade. The present invention is directed to meeting these needs.

### SUMMARY OF THE INVENTION

It is an object of the present invention to provide a new and useful support housing for business signage and a sign and method related to such signage.

Another object of the present invention is to provide a new and useful housing particularly for electrified neon signs.

Still a further object of the present invention is to provide a standardized housing for signs that can be permanently affixed to the facade of a building so as to allow signage to be changed by merely changing the faceplate thereof.

Still a further object of the present invention is to provide a standardized housing for signs that does not need to be customized.

Yet another object of the present invention is to provide a housing and a signage method that is less costly in implementation.

According to the present invention, then, a support structure is adapted to be secured to an upright surface and is operative to mount and support signage thereon. In addition to such support structure, the present invention provides a completed sign adapted to be secured to the upright support surface. The sign may be an electrified sign adapted to connect to an electrical power source. The present invention also concerns a method of creating such a sign.

In its broad form, the support structure of the present invention includes a longitudinally extending housing that is adapted to be secured to the upright surface. This housing has an interior and a longitudinally extending open front. End panels form opposite ends of the housing. At least one gusset panel is disposed in the interior of the housing and is oriented transversely thereof. This gusset panel is operative to rigidify the housing and includes a forwardly disposed notch that faces the open front of the housing. Where the present invention provides a completed sign, a longitudinal face plate is mounted to the housing and extends across the open front to enclose the interior of the housing. The faceplate includes at least one display character on a front face thereof. If desired, the housing can have an open top, and, in such event, the invention includes a removable lid sized and adapted to enclose the open top.

In greater detail, the housing can include a primary panel forms both a bottom wall and a rear wall that are joined together at a lower rear edge portion. The bottom wall extends forwardly to a lower front edge portion and the rear wall extends upwardly to an upper rear edge portion. The gusset panel is then secured to the bottom wall and to the rear wall of the primary panel. A front panel strip is secured to and is supported by the gusset panel to form an upper front edge portion of the housing. The front opening is then located between the front panel strip and the lower front edge portion of the bottom wall.

In the exemplary embodiment, the lower front edge portion of the bottom wall includes an upturned flange. The front panel strip includes a flat strip section with the upturned flange and the flat strip section defining a front face for the housing. This front face is then adapted to mount the signage. Here, also, the upturned flange and the flat strip section are generally oriented in a common plane. The gusset panel then includes a lower nose portion that abuts the upturned flange and an upper nose portion that abuts the flat strip section.

Further, in the exemplary embodiment, the upper rear edge portion includes longitudinally extending webs that define an upper rear shoulder. The front panel strip also includes longitudinally extending webs defining an upper front shoulder that is generally parallel to and spaced apart from the upper rear shoulder thereby to form a longitudinally extending open top to the housing. Here, then, a removable lid is sized and adapted to enclose the open top.

In the exemplary embodiment, a plurality of gusset panels are disposed in the interior of the housing with these gusset panels being in spaced apart relation to one another. Whether one or more gusset panels are provided, each may include a flat central panel piece and a gusset web oriented generally perpendicularly to the flat central panel piece. In the exemplary embodiment, this gusset web extends substantially around the perimeter of the central panel piece. Where a plurality of gusset panels are provided, the notches thereof form a raceway adapted to receive electrical wiring for the signage.

As noted above, the present invention also contemplates a sign adapted to be secured to the upright surface. Here, the sign includes the housing, as described above, and at least one gusset panel as described above. The sign further includes a longitudinal faceplate that is mounted to the housing and extends across the open front to enclose the interior. This faceplate includes at least one display character on the front face thereof. This character may be an electrified character, and, in which case, the faceplate includes a longitudinally extending wiring harness located on a rear face thereof. The notch in each gusset panel (whether there be one or more) is then sized and adapted to receive the wiring harness when the faceplate is mounted on the housing. The electrified character may be a neon light. Here, a transformer is disposed in the interior of the housing with the transformer being in electrical communication with the electrified character by way of the wiring harness. In the exemplary embodiment, the faceplate includes a plurality of electrified display characters with each of the display characters then being in electrical communication with the wiring harness.

It is further contemplated that the housing have end panels with at least one but preferably both provided with punch out sections. This allows a plurality of housings to be aligned, end-to-end, with adjacent end panels having their punch out sections removed to allow passage of the wiring harness therethrough. Moreover, in the even that the faceplate is longer in longitudinal dimension then the housing, an extension piece may be secured to one or both of the end panels. This extension piece has an interior that may be placed in communication with the interior of the housing through the punch out section.

Also, as noted above, the present invention is directed to a method of providing an electrified sign display on an upright surface that has an electric power source associated therewith. Here, the method includes the step of providing a longitudinal extending housing secured at a selected location to the upright surface wherein the housing has an interior and a longitudinally open front that includes an open raceway extending longitudinally therein. The method then includes the step of fabricating a faceplate that is sized to cover the open front of the housing with the faceplate including at least one display character mounted on a front face thereof and a longitudinally extending electrical harness on a rear face thereof. The display character, of course, is operative to emit light in response to electrical power applied thereto. The method then includes establishing electrical communication between the display character and the wiring harness and thereafter mounting the faceplate to the housing such that the faceplate covers the open front of the housing with the electrical harness being received in the raceway. The method then includes establishing electrical communication between the electric harness and the electrical power source. Naturally, the method can include any of these steps that are inherent in the structure of the invention.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of a representative storefront according to the prior art showing a sign mounted to a facade on a marquis thereof;

FIG. 2 is a perspective view of a sign according to a first exemplary embodiment of the present invention;

FIG. 3 is a top plan view of the sign shown in FIG. 2 having the access lid thereof removed to show the interior thereof;

FIG. 4 is an exploded view in cross-section showing the sign of FIGS. 2 and 3 using the standardized housing of the present invention;

FIG. 5 is a perspective view of an end portion the primary housing panel used to form the housing of FIGS. 2-4;

FIG. 6 is a perspective view of a portion of a housing strip used to form the housing of FIGS. 2-4;

FIG. 7 is a perspective view of a gusset panel used to form the housing of FIGS. 2-4;

FIG. 8 is a perspective view of a representative end panel used to form the housing of FIGS. 2-4;

FIG. 9 is a perspective view of an alternative embodiment of the present invention utilizing faceplate extensions;

FIG. 10 is a perspective view of an extension piece used with the sign of FIG. 9;

FIG. 11 is a perspective view of an alternate embodiment of the gusset panel used in the present invention;

FIG. 12 is a perspective view of an alternative end plate used with the gusset panel of FIG. 11;

FIG. 13 is a perspective view of an end portion of a housing according to the present invention using the gusset panels of FIG. 11 and the end plate of FIG. 12; and

FIG. 14 is a perspective view of an end portion of a housing according to the present invention using the gusset panels of FIG. 11, a modified extension piece and the end plate of FIG. 12.

### DETAILED DESCRIPTION OF THE EXEMPLARY EMBODIMENTS

The present invention is broadly directed, then, to signs such as those typically mounted on the external facade of business premises. More particularly, the present invention specifically concerns standardized housing supports for such signs as well as signs that incorporate these standardized supports. In addition, the present invention includes a method for forming standardized signage. This structure and method, accordingly, provides new and useful structures and methods for signs of individual businesses which may stand-alone or be associated with other businesses so that a universal theme or appearance may be provided. The present invention further concerns standardized housings which may received different sign faceplates, especially as those incorporating electrified elements, such as neon signs and the like.

Although the present invention is described with respect to neon signs, it should be appreciated that the structures described herein can be employed for other signs as well. For example, the standardized housing may be used to provide a support for faceplates that are either illuminated by ambient light or are otherwise externally lighted. The present structures may also be used, if desired, for internally illuminated signs using translucent or transparent faceplates. Accordingly, although the present invention is described with respect to neon signs, the present invention has broader applications as may be appreciated by the ordinarily skilled person in this field.

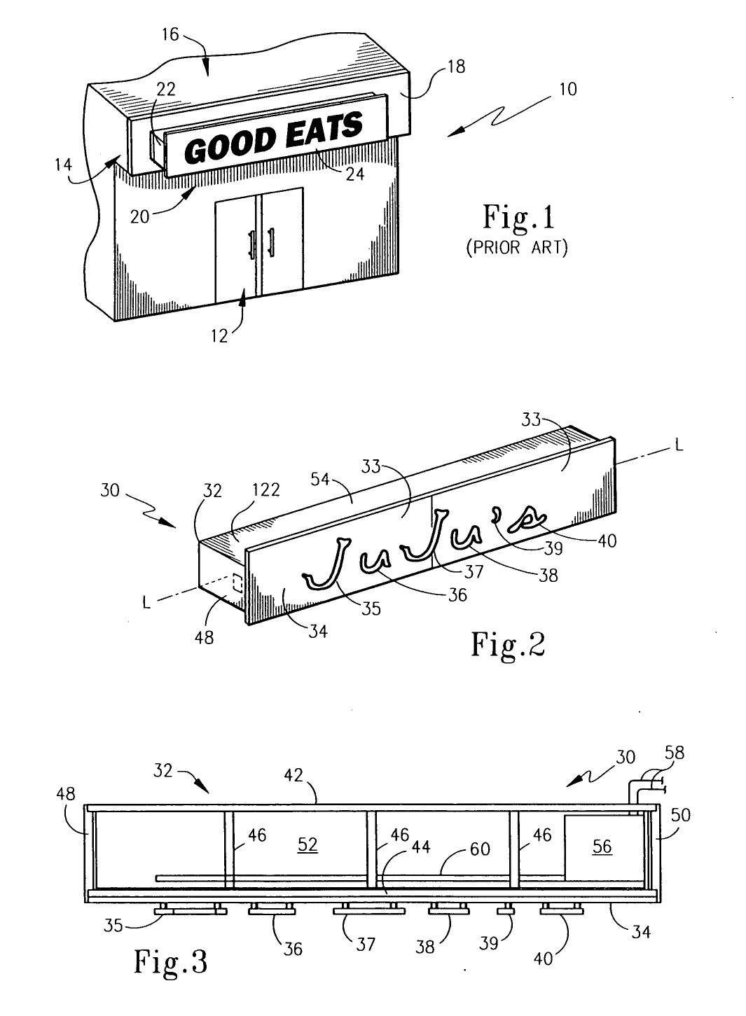

With reference first to FIG. 1, it may be seen that a representative business premises 10 according to the prior art has an entryway 12 formed by a pair of doors. A marquee 14 extends above entryway 12 and projects forwardly of the building 16 housing the premises 10. Marquee 14 has a facade 18 that provides a representative upright support surface upon which a sign 20 may be supported. Sign 20 includes a support housing 22 and a faceplate 24 on which alpha characters appear, here spelling out the phrase “Good Eats”. As is known, the characters may be internally illuminated, externally illuminated, illuminated by ambient light or electrified, such as the known neon sign.

A first exemplary embodiment of the present invention, though, is introduced in FIG. 2, the structure of which is described in greater detail with respect to FIGS. 3-8. In FIG. 2, it may be seen that sign 30 according to the first exemplary embodiment includes a housing 32 and a faceplate 34 which supports a plurality of characters 35, 36, 37, 38, 39 and 40 on a front face thereof. In this exemplary embodiment, characters 35-40 are constructed as neon tubes, here forming the name “JuJu's”. Housing 32 is elongated in a direction of longitudinal axis “L”. Housing 32 includes a lid 54 that is secured thereto, but which may be removed to allow access to the interior of housing 32.

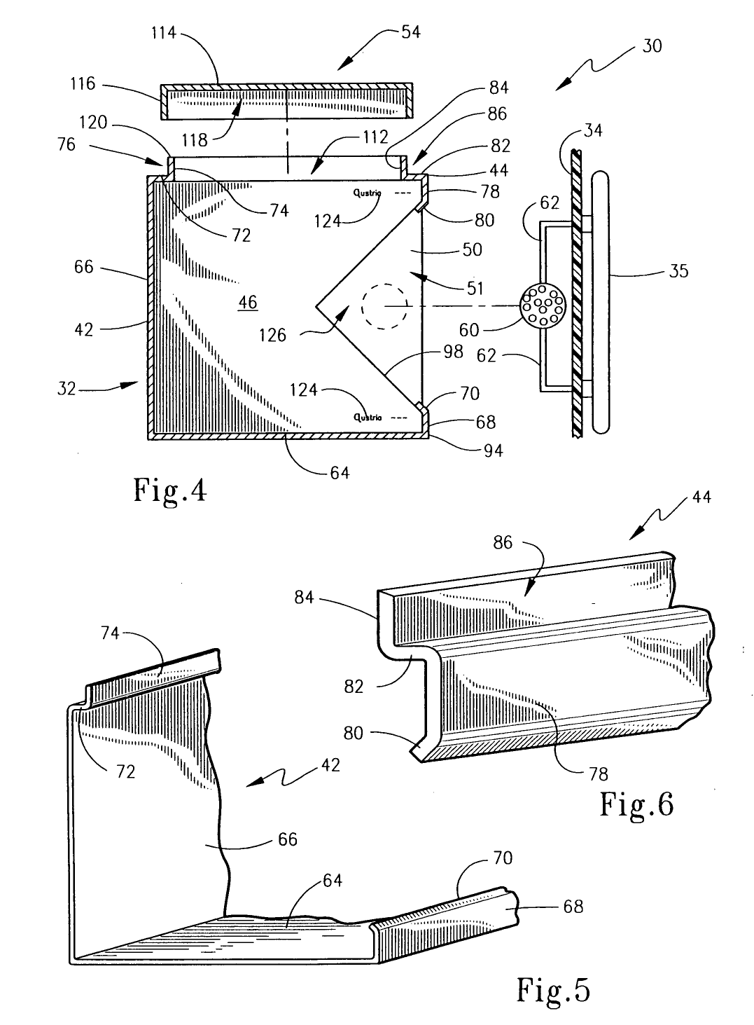

With reference to FIGS. 3 and 4, it may be seen that housing 32 has a primary housing panel 42 and a front panel strip 44 that are structurally supported in spaced relation to one another by means of a plurality of gusset panels 46. The ends of housing 42 are enclosed by end panels 48 and 50 so as to define an interior 52 for housing 32 with housing 32 thus having an open front 51 (FIG. 4). Interior 52 may be enclosed by a lid 54 (FIG. 2) as noted above.

A transformer 56 includes power lines 58 that communicate with a suitable electrical power source (not shown). A wiring harness 60 then electrically communicates which each of elements 35-40 that are attached to faceplate 34 so that electrical power may be supplied to each of elements 35-40. Thus, for example, as is shown in FIG. 4, wires 62 extend from wiring harness 60 to neon lighting element 35. Wiring harness 60 extends longitudinally of the faceplate on a rear face thereof.

The structure of primary housing panel 42 is further illustrated in FIG. 5 where it may be seen that primary housing panel 42 includes a bottom panel or wall 64 that is joined to a back panel or back wall 66, here illustrated to be perpendicular to one another, although perpendicularity is not, of course, required. Bottom wall 64 extends forwardly to a lower front edge portion that includes an upturned bottom flange 68 formed at right angles to bottom wall 64 in an upward inwardly turned lip 70 formed at a 45-degree angle to flange 68. Rear wall 66 extends upwardly from bottom wall 64 and has an upper rear edge portion formed by a web 72 and 74. Web 72 is oriented at a right angle with respect to back wall 66, and web 74 is oriented at a right angle to web 72 so as to define an upper rear shoulder 76 at the upper rear edge portion of rear wall 66. In the exemplary embodiment, primary housing panel 42 is constructed as an integral one piece of metal, such as aluminum, steel, etc., that is folded, stamped or otherwise manufactured to create the structure described.

Front panel strip 44 is best illustrated in FIGS. 4 and 6 and includes a flat strip section 78 that terminates in an inwardly turned lip 80 formed at a 45-degree angle with respect to flange portion 78. An upper web 82 is formed at right angles to flat strip section 78, and an upper web 84 is formed at right angles to web 82 so as to form a shoulder 86 at the upper front edge of housing 32. Front panel strip 44 may be, for example, formed as a folded or stamped metal construct of integral one-piece construction, again of aluminum, steel and the like. Alternatively, front panel strip 44 may be formed as a metal extrusion, if desired.

In any event, primary housing panel 42 and front panel strip 44 are structurally connected and supported relative to one another by a plurality of gusset panels 46, as shown in FIGS. 3 and 4 so as to form the open front 51 for housing 32 that is located between the front panel strip 44 and the lower front edge portion of bottom panel 64. Flat strip section 78 and upturned flange 68 are oriented generally in a common plane and define a front face for housing 32 adapted to mount faceplate 34.

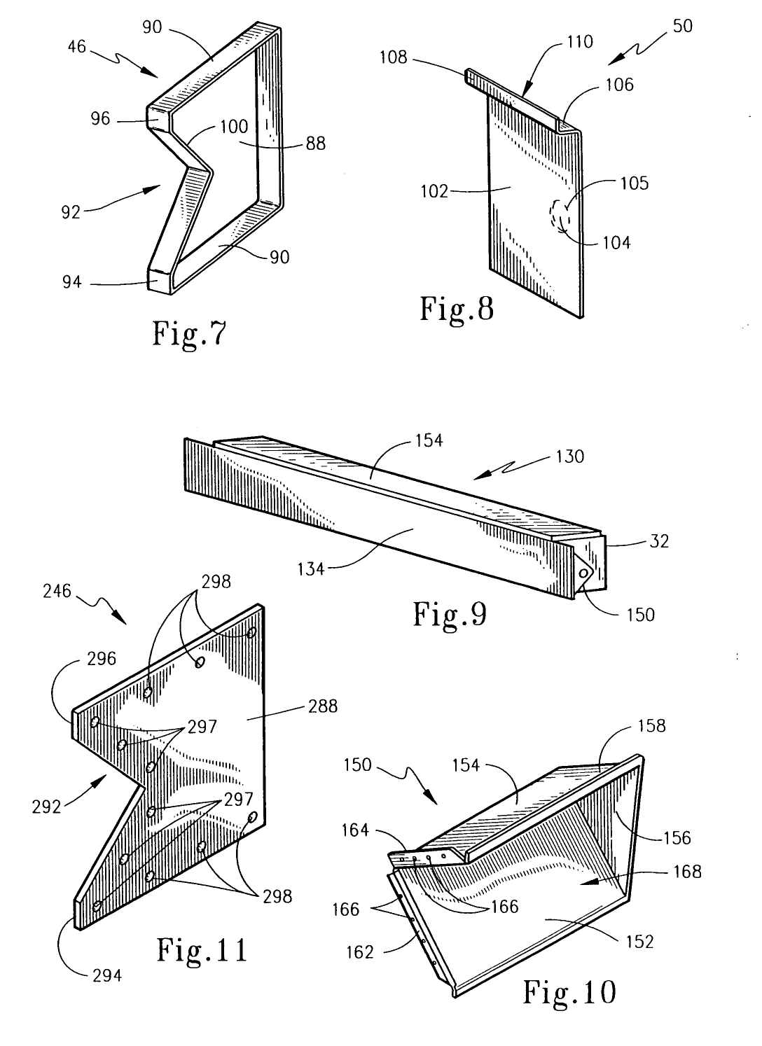

A representative gusset panel 46 is illustrated in FIG. 7 and includes a flat central panel piece 88 surrounded by a peripheral web 90 formed at right angles thereto and which extends around the entire perimeter of central panel piece 88, although it is not necessary for the invention that this web extend completely therearound. Gusset panel 46 has a V-shaped notch region 92 that extends between a lower nose 94 and an upper nose 96 with notch web portions 98 being oriented at right angles with respect to one another. Again, the gusset panels 46 may be formed as an integral one piece of metal, such as aluminum, steel, etc., that is folded to create the structure described. When assembled, lower nose 94 abuts upturned flange 68 and upper nose 96 abuts flat strip section 78.

Returning to FIG. 4, it may be seen that each gusset panel 46 is affixed to primary housing panel 42 in any convenient manner, such as by welding, screws, or the like, with nose 94 nested against flange 68 such that lip 70 confronts notch web portion 98. A top portion of peripheral web 90 confronts web 72 and is also affixed thereto. Front panel strip 44 is secured to nose 96 with nose 96 nested against flange portion 78 with web portion 100 confronting lip 80 and with the top portion of peripheral web 90 also confronting web 82. Again, front panel strip 44 is secured to each gusset 46 such as by welding and the like. Therefore, gusset panels 46 act to rigidify the housing 32.

End panels 48 and 50 then include the outer most ends defined by primary housing panel 42 and front panel strip 44 which are elongated and extend in parallel relation to one another. A representative end panel 50 is illustrated in FIG. 8, and it should be appreciated that end panel 48 is the mirror image of end panel 50 so that the details of the construction of end panel 48 may be fully appreciated by describing end panel 50. In FIG. 8, then, end panel 50 is shown to include a flat end plate 102 that is circularly scored to forms an optional punch-out 104, the purpose of which is described below with respect to the second exemplary embodiment of the present invention. It should be understood, however, that punch-out 104 is not required in the construction of housing 32. In either event, an upper portion of end panel 50 includes a web 106 formed at a right angle to flat end piece 102, and a second web 108 is formed at a right angle to web 106 thereby to form a shoulder 110. End panel 50 (and end panel 48) may again be formed as a single integral construction of folded metal, as described with respect to the other components of housing 32.

End panels 48 and 50 are joined to the opposite ends of primary housing panel 42 and front panel strip 44, such as by welding or the like thereby to create the interior 52 noted above. When assembled, shoulders 76, 86 and 110 form a seat for lid panel 54 and define a mouth 112 opening into the interior of housing 32. To this end, as is illustrated in FIG. 4, lid 54 includes a lid panel 114 surrounded by downwardly depending peripheral web 116 so as to create a cavity 118 that nests with the upper peripheral edge 120 of housing 32 lid panel 54 may be secured to housing 32 by means of a plurality of screws 122 which extend through peripheral web 116 at desired locations and affix to webs, such as webs 74, 84 and/or 108.

Again with reference to FIG. 4, it may be seen that faceplate 34 attaches to housing 32 by means of screws or bolts 124. Notches 92, along with faceplate 34 thereby create an open raceway 126 that can accommodate wiring harness 60 along with wires 62 without impediment from the structure of housing 32.

By providing housing 32 with the construction described, it becomes a simple and relatively inexpensive process to produce a sign 30. Housing 32 may be formed in standardized dimensions to accommodate a desired height of a faceplate 34 and with a standard depth so as to accommodate transformer 56. These housings may be powder-coated to preserve them against environmental conditions, and they may be colored to match a desired decor.

The housings can be square shaped in cross-section and dimensioned approximately 8 inches by 8 inches. Alternatively, the depth of housing 32 have almost any depth and height as desired. It is contemplated that the depth usually be set at approximately 8 inches and the height modified as desired. This creates a non-square rectangular housing that is higher than it is deep. It should be further appreciated that the housings according to this invention can have cross-sections, other than rectangular or square, and other sizes as would be within the skill of the ordinary artisan in this field.

Moreover, standard lengths of housings 32 may be provided, for example, in 3 foot, 5 foot and 8 foot lengths. Likewise, the faceplates 34 can be of standardized lengths so that the complete faceplate is comprised of several faceplate sections, such as sections 33 in FIG. 2. Different length signs may then be created by ganging different combinations of the standard lengths, with each of the selected housings having a common height. Here, punch-outs 104 may be removed from their scoring lines 105 to provide communication between the interiors of the ganged together housings. Any necessary wiring may then be passed through the registered openings created by the removal of punch out 104 so as to be connected ultimately to transformer 56.

Further, in the process of constructing a sign, once a standardized housing 32 is mounted to the facade 18 of a business premise 10, it is only necessary for the sign maker to create the sign's message in the form of the characters thereon mounted to a standardized faceplate 34. Thus, a standardized faceplate 34 having a height that is substantially the same as housing 32 and a length that is substantially the same may be secured to cover the open front of housing 32. Characters, such as characters 35-40 are mounted on faceplate 34, usually at a location that is remote from the business premise. The suitable electrical interconnects, such as elements 35-40 are made by way of wiring harness 60 and wires 62. Thereafter, the faceplate with the characters and wiring mounted thereto may be assembled on the housing 32 by means of screws 124, as noted above. Raceway 126 provides passageway for wiring harness 60, and the electrical interconnects to transformer 56 may be accomplished by removing lid panel 54 to allow access to the interior of housing 32. This obviates the need to “fish” wires through the housing panel. After electrical connection, lid panel 54 may be re-secured to enclosed housing 32.

Thus, it can be appreciated that the present invention saves costs in at least two ways. On one hand there is a reduction in expensed associated with the damage to the premises that occurs with the existing protocol. On the other hand, there are substantial labor savings costs to the sign fabricator. Here, the fabricator can make the sign panel at a centralized shop and then take the completed sign panel to the desired location. Since the housing has an open front, since the raceway is provided for wiring clearance and since the top of the housing can be removed, it then becomes a simple and time-efficient process to mount the sign panel to the housing with the wiring intact. The interconnects to the power source can be achieved simply, again with time and labor savings. It then becomes a simple matter to re-secure the top of the housing, thereby completing a sign assembly.

In some instances, due to the length of the message that may be presented by the sign, it is foreseen that a sign slightly longer than a standardized housing 32 might be desired. Accordingly, the present invention contemplates extension pieces for use with a standard housing to create a second exemplary embodiment of the present invention as is illustrated in FIG. 9. Here, sign 130 is illustrated (without the characters) with sign 130 including a standard housing 32 of the type described above, including a lid 54. Faceplate 134 is mounted to housing 32 with faceplate 134 being slightly longer than housing 32. Accordingly, a pair of extensions are located at and secured to each end of housing 32 as an extension thereof. In FIG. 9, a single extension 150 is illustrated, although it should be appreciated that an identical extension is located at an end of housing 32 opposite the illustrated extension housing 150. Each of these extension pieces 150 may be of standardized length, such as twenty-one inches.

A representative extension housing 150 is illustrated in FIG. 10 and includes first and second panels 152 and 154 formed at right angles to one another and then end panel 156 also at right angles to panels 152 and 154. A U-shaped face panel flange 158 extends around one edge of each of panels 152, 154 and 156 with flange 158 being provided to secure the outer end edges of face panel 134 thereto. Mounting webs 162 and 164 extend respectively from panels 152 and 154, at right angles thereto, and include mounting holes 166 such that extension piece 150 may be secured to an end panel, such as end panel 48, by means of screws, bolts, and the like.

Extension piece 150 thus has an interior 168 to accommodate wiring for any character elements that occur on the end portions of faceplate 134 associated with each extension 150. Each of the end panels may be provided with punch-outs, such as optional punch-outs 104 described above with respect to end panels 48 and 50. The purpose and function of these punch-outs 104 may now be appreciated. Where extensions 150 are desired, punch-outs 104 may be removed from their scoring lines 105 to provide communication between interior 168 of each extension piece 150 and the interior 52 of housing 32. Any necessary wiring may then be passed through the opening created by the removal of punch out 104 so as to be connected ultimately to transformer 56. Subsequently, if desired, if it is desired to seal this opening, it is a simple matter to affix a repair plate (not shown) over the opening.

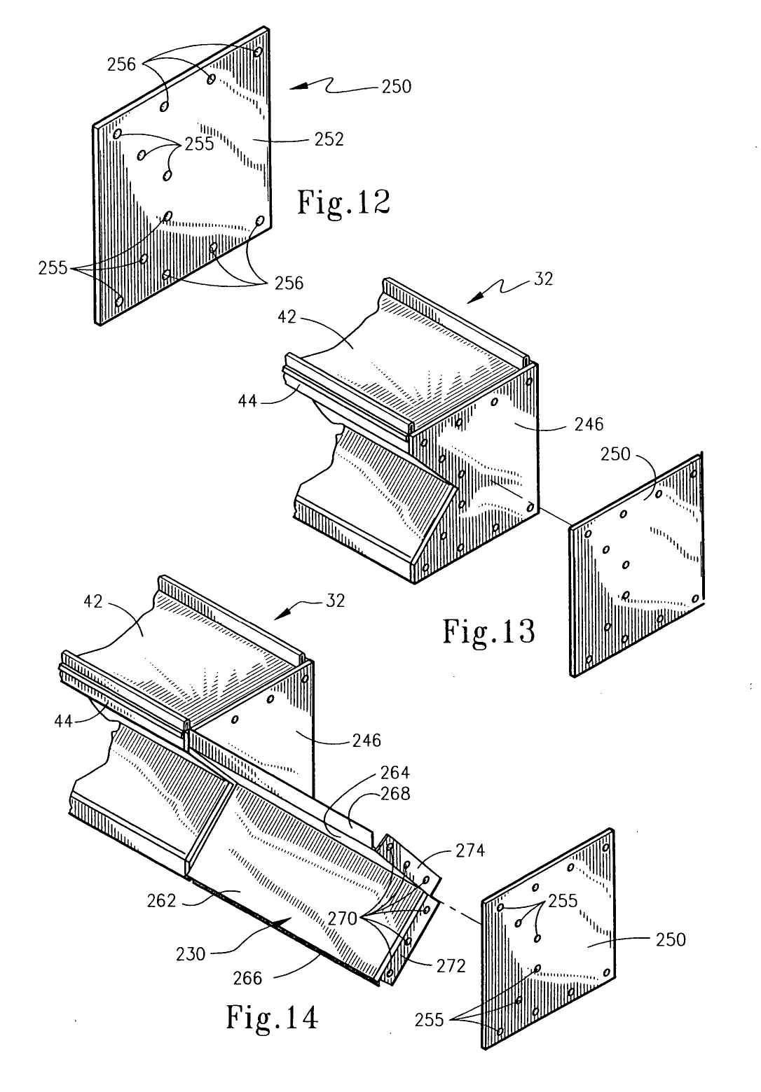

An alternative embodiment of a gusset panel that may be used with the present invention is shown in FIG. 11 and an alternative embodiment of an end panel is illustrated in FIG. 12. In FIG. 11, gusset panel 246 is shown to be formed by a flat plate 288 that has a V-shaped notch region 292 formed therein. V-shaped notch region 292 extends between a lower nose 294 and an upper nose 296. Holes 297 extend along the edges of notch 292 while holes 298 extend along the upper and lower edges of plate 288.

As is illustrated in FIG. 12, an alternative end panel 250 is formed by a flat plate 252 that has a V-shaped arrangement of holes 255 and holes 256 along its top and bottom edges. Holes 255 are positioned to register with holes 297 when end panel 255 abuts a gusset panel 246 with holes 256 also registering with holes 298.

It should be understood that a plurality of gusset panels 246 are positioned in housing 32, as described above, so as to rigidify housing panel 42 and to support front panel strip 44. In addition, as is illustrated in FIG. 13, a gusset panel 246 may be mounted at each end of housing 32 so as to help form an end closure therefor. Alternatively, such gusset panel 246 may form a panel to mount an extension piece 230, as is illustrated in FIG. 14. When the fabricator is desirous of making an end closure, an end panel 250 can be placed in abutting relationship with gusset panel 246 located at an end of housing 32 as is illustrated in FIG. 13.

Alternatively, extension piece 230 may be mounted onto gusset panel 246 as is illustrated in FIG. 14, to accommodate a face panel that is longer than housing 32. To this end, it should be appreciated that extension piece 230 is modified from that described above with respect to FIG. 10. Here, end wall 156 is removed so that first and second panels 262 and 264 support upper and lower webs 266 and 268 and opposite end webs such as 272 and 274. In order to enclose the distal end of extension piece 230, an end panel 250 can be mounted against webs 274 using holes 255 which align with holes 270 thereon.

This structure using gussets 246 and endplates 250 and with optional extension piece 230 further simplify the structure. Where gusset panels 246 are used at the ends of the housings 32, it is a simple matter to assemble a plurality of housings 32 together to create a longer housing without having to rely on any knockouts.

The present invention further includes a method of providing an electrified sign display on an upright surface that has an electric power source associated therewith. This method may include any processing step inherent in the above-identified structures and assembly, as discussed. Generally, the method includes a first step of providing a longitudinally extending housing secured at a selected location to the upright surface wherein this housing has an interior and a longitudinally extending open front and that includes an open raceway extending longitudinally therein. The method further includes the step of fabricating a faceplate that is sized to cover the open front of the housing with said faceplate including at least one display character mounted on a front face thereof and a longitudinally extending electrical harness on a rear face thereof wherein the display character is operative to emit light in response to electric power applied thereto. Electrical communication is then established between said display character and said wiring harness. Thereafter the faceplate is mounted to the housing such that the faceplate covers the open front of the housing with the electrical harness being received in the raceway. Electrical communication is then established between the electric harness and the electrical power source.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A support structure adapted to be secured to an upright surface and operative to mount and support signage thereon, comprising:
(A) a longitudinally extending housing having opposite ends and adapted to be secured to the upright surface, said housing having an interior and a longitudinally extending open front; and
(B) at least one gusset panel disposed in the interior of said housing and oriented transversely thereof and operative to rigidify said housing, said gusset panel having a forwardly disposed notch facing the open front.

2. A support structure according to claim 1 wherein said housing has a longitudinally extending open top and including a removable lid sized and adapted to enclose the open top.

3. A support structure according to claim 1 wherein said housing includes:
(1) a primary panel forming a bottom wall and a rear wall joined together with said bottom wall extending forwardly to a lower front edge portion and with said rear wall extending upwardly to an upper rear edge portion, said gusset panel secured to the bottom wall and the rear wall of said primary panel; and
(2) a front panel strip secured to and supported by said gusset panel whereby the front opening is located between said front panel strip and said lower front edge portion.

4. A support structure according to claim 3 wherein the lower front edge portion of said bottom wall includes a upturned flange and wherein said front panel strip includes a flat strip section, said upturned flange and said flat strip section defining a front face for said housing adapted to mount said signage.

5. A support structure according to claim 4 wherein said upturned flange and said flat strip section are generally oriented in a common plane.

6. A support structure according to claim 4 wherein said gusset panel includes a lower nose portion abutting said upturned flange and an upper nose portion abutting said flat strip section.

7. A support structure according to claim 3 wherein said upper rear edge portion includes longitudinally extending webs defining an upper rear shoulder and wherein said front panel strip includes longitudinally extending webs defining an upper front shoulder generally parallel to and spaced apart from said upper rear shoulder thereby to form a longitudinally extending open top for said housing, and including a removable lid sized and adapted to enclose the open top.

8. A support structure according to claim 1 wherein said housing includes opposite end panels.

9. A support structure according to claim 8 including an extension piece secured to said first one of said end panels, said extension piece having an extension piece interior in communication with the interior of said housing.

10. A support structure according to claim 9 wherein said end panels each can be selectively secured to a respective said gusset panel and to a respective extension piece.

11. A support structure according to claim 1 wherein said gusset panel includes a flat central panel piece and a gusset web oriented generally perpendicularly to said flat central panel piece.

12. A support structure according to claim 1 including a plurality of gusset panels disposed in spaced-apart relation in the interior of said housing and oriented transversely thereof, each said gusset panel having a forwardly disposed notch facing the open front of said housing, said notches forming a raceway adapted to receive electrical wiring for said signage.

13. A support structure according to claim 12 including a said gusset panel at each of the opposite ends of said housing.

14. A sign adapted to be secured to an upright surface, comprising:
(A) a longitudinally extending housing adapted to be secured to the upright surface and having an interior and a longitudinally extending open front;
(B) at least one gusset panel disposed in the interior of said housing and oriented transversely thereof and operative to rigidify said housing, said gusset panel having a forwardly disposed notch facing the open front; and
(C) a longitudinal faceplate mounted to said housing and extending across the open front to enclose the interior, said faceplate including at least one display character on a front face thereof.

15. A sign according to claim 14 wherein character is an electrified character, said faceplate including a longitudinal wiring harness located on a rear face thereof, said notch sized and adapted to receive said wiring harness when said faceplate is mounted on said housing.

16. A sign according to claim 15 wherein said character is a neon light, and including a transformer disposed in the interior of said housing and in electrical communication with said character by way of said wiring harness.

17. A sign according to claim 15 wherein said faceplate includes a plurality of electrified display characters disposed on the front face thereof with said display characters in electrical communication with said wiring harness, and including a plurality of gusset panels disposed in spaced-apart relation in the interior of said housing and oriented transversely thereof, each said gusset panel having a forwardly disposed notch facing the open front of said housing, said notches forming a raceway operative to receive said wiring harness when said faceplate is mounted to said housing.

18. A sign according to claim 14 wherein said housing has a longitudinally extending open top and including a removable lid sized and adapted to enclose the open top.

19. A sign according to claim 14 wherein said housing includes:
(1) a primary panel forming a bottom wall and a rear wall joined together with said bottom wall extending forwardly to a lower front edge portion and with said rear wall extending upwardly to an upper rear edge portion, said gusset panel secured to the bottom wall and the rear wall of said primary panel; and
(2) a front panel strip secured to and supported by said gusset panel whereby the front opening is located between said front panel strip and said lower front edge portion.

20. A sign according to claim 19 wherein the lower front edge portion of said bottom wall includes a upturned flange and wherein said front panel strip includes a flat strip section, said upturned flange and said flat strip section are generally oriented in a common plane and define a front face for said housing whereby said faceplate may be supported thereagainst.

21. A sign according to claim 19 wherein said gusset panel includes a lower nose portion abutting said upturned flange and an upper nose portion abutting said flat strip section.

22. A sign according to claim 14 wherein said gusset panel includes a flat central panel piece and a gusset web oriented generally perpendicularly to said flat central panel piece.

23. An electrified sign adapted to be secured to an upright surface in communication with an electrical power source, comprising:
(A) a longitudinally extending a primary panel forming a bottom wall and a rear wall joined together with said bottom wall extending forwardly to a lower front edge portion and with said rear wall extending upwardly to an upper rear edge portion and adapted to be secured to the upright surface, the lower front edge portion of said bottom wall including a flat, upturned flange;
(B) a plurality of gusset panels mounted to said primary panel and oriented transversely thereof in spaced-apart relation to one another, at least some of said plurality of gusset panels having a forwardly disposed notch formed by a lower nose portion and an upper nose portion, each said lower nose portion abutting said upturned flange;
(C) a front panel strip secured to and supported by the upper nose portions of said some of said plurality of gusset panels and wherein said front panel strip includes a flat strip section;
(D) first and second end panels disposed at opposite ends of said primary panel whereby said primary panel, said front panel strip and said end panels form a housing having an interior, a longitudinally extending open front located between said upturned flange and said front panel strip and a longitudinally extending open top located between said front panel strip and said upper rear edge portion, and wherein the notches in said some of said plurality of gusset panels face the open front and define a raceway and wherein said flat strip section and said upturned flange are oriented generally in a common plane and define a front face for said housing;
(E) a longitudinal faceplate mounted to said housing and extending across the open front to enclose the interior, said faceplate including a plurality of electrified display characters on a front face thereof and a wiring harness on a rear face thereof, said wiring harness adapted to establish electrical communication between said power source and said display characters, said raceway operative to receive said wiring harness when said faceplate is mounted to the front face of said housing; and
(F) a removable lid enclosing the open top of said housing.

24. A method of providing an electrified sign display on an upright surface that has an electric power source associated therewith, comprising:
(A) providing a longitudinally extending housing secured at a selected location to the upright surface wherein the housing has an interior and a longitudinally extending open front and that includes an open raceway extending longitudinally therein;
(B) fabricating a faceplate that is sized to cover the open front of the housing with said faceplate including at least one display character mounted on a front face thereof and a longitudinally extending electrical harness on a rear face thereof wherein said display character is operative to emit light in response to electric power applied thereto;
(C) establishing electrical communication between said display character and said wiring harness;
(D) thereafter mounting said faceplate to said housing such that said faceplate covers the open front of said housing with said electrical harness being received in the raceway; and
(E) establishing electrical communication between said electric harness and the electrical power source.
